(19) United States
(12) Patent Application Publication
(10) Pub. No.: US 2012/0246004 A1
(43) Pub. Date: Sep. 27, 2012

(54) SYSTEMS AND METHODS FOR CUSTOMER INTERACTION

(76) Inventors: Christopher J. Book, Paradise Valley, AZ (US); JoyAnn M. Book, Paradise Valley, AZ (US)

(21) Appl. No.: 13/335,528

(22) Filed: Dec. 22, 2011

Related U.S. Application Data
(60) Provisional application No. 61/426,100, filed on Dec. 22, 2010.

(51) Int. Cl. G06Q 30/02

(52) U.S. Cl. 705/14.58; 705/347

(57) ABSTRACT

Pursuant to some embodiments, methods, systems, apparatus, and computer program code for encouraging customer interaction are provided. In some embodiments, customer interaction may include receiving a request by a user operating a mobile device to provide feedback associated with an experience at a merchant. Device location data is identified associated with a current location of the mobile device. Merchant location data associated with a location of the merchant is identified, where the merchant location data includes information identifying a permitted review radius. A determination is made whether the current location of the mobile device is within the permitted review radius, and, if so, the user is permitted to provide feedback.

### CROSS-REFERENCE TO RELATED APPLICATIONS

This application is based on, and claims benefit of and priority to, U.S. Patent Application Ser. No. 61/426,100, the contents of which are hereby incorporated in their entirety for all purposes.

### BACKGROUND

Brick and mortar retailers and other merchants serving a local area (“merchants”) continually face challenges related to customer acquisition and retention. Search engines, social networking sites (such as Facebook.com) review sites (such as Yelp.com) and location-based services (such as Foursquare) provide some retailers with an ability to list their business and passively attract customers, while focusing mainly on the consumer rather than business needs. However, merchants (and their consumers) have no satisfactory ability to engage with existing and potential customers in a way that improves customer experience, encourages customer loyalty and attracts new customers. Further, merchants do not have the ability to currently respond directly to customer feedback or reviews in a real-time manner or guarantee the validity of the feedback by knowing if the person is or has been an actual customer, limiting their ability to facilitate customer service and receive actionable feedback. Additionally, the location-based services and review sites have not provided businesses with a method for managing multiple locations under one account, nor have they provided this means for interaction with and analytics tracking of on-premise customers.

Systems are desired for improving customer interaction, with the merchants and each other, improving response time to customer feedback and bringing the online communities into the real world brick-and-mortar stores. On the business side, systems are also desired to not only measure, track and manage customer interaction and feedback and reward loyalty of every location owned by an individual, group or company on one platform, but also integrate existing customer intelligence data and marketing platforms onto this platform.

### BRIEF DESCRIPTION OF THE DRAWINGS

FIG. 1 is a block diagram of a system according to some embodiments.

FIG. 2 is a flow chart showing a process pursuant to some embodiments.

FIG. 3 is a flow chart showing a further process pursuant to some embodiments.

FIGS. 4A-4D are generalized views of user interfaces according to some embodiments.

FIGS. 5A-5F are generalized views of user interfaces according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art. Applicants have discovered that encouraging and receiving customer feedback while a customer is actually at a merchant location provide more authentic, accurate and actionable feedback to the merchant. Embodiments of the present invention allow merchants to encourage and receive feedback from customers who have actually visited a physical merchant location.

Pursuant to some embodiments, systems and methods are provided which allow businesses and customers to develop relationships through user-generated feedback and location-based technologies. Users, operating mobile devices and other computing devices, create live (or substantially live) on-premise feedback of a merchant location or establishment to establish the validity of the consumer providing feedback to said merchant.

Users, operating mobile devices and other computing devices, can also create live (or substantially live) on-premise or after the fact feedback of a merchant location or establishment after a coupon, deal, discount, loyalty reward or the like has been redeemed on-premise, through a mobile or other computing device or online, to establish the validity of the consumer providing feedback to said merchant. By encouraging live or substantially live feedback during a customer interaction with a merchant (with customers proven to be on-premise by GPS technology, by redemption of said deals, by manual input of code, by “bump” technology allowing users to tap their device on another device or a form of marketing collateral with an embedded chip to guarantee proximity or by the scanning of a code, like QR or another form of 2D or 3D codes or barcodes, all to verify location or validity of the customer of said merchant), the relevance of feedback and engagement with a customer are increased. Verification of a customer interaction with a merchant may further be done with a checkin of the customer at a merchant location, or a customer's verified usage of a known wireless network at the merchant location. Further, embodiments allow users to view other feedback and reviews of merchants and vote or comment on that feedback. The result is a system that both engages customers and encourages accurate and relevant feedback from real customers on-location. Additionally, users may scan a bar code of an item to associate with feedback, providing more relevance to their feedback. In addition to free-form user feedback, businesses may administer private surveys that contain free form questions and in some embodiments multiple choice answers that customers complete for businesses. These may be public or not visible to the general public and provide businesses with a means to track, measure and respond to specific or targeted questions from their on-location or redeeming customer base.

Merchants may use features of the present invention to directly communicate with customers to act upon poor feedback, create new relationships, and foster existing relationships while the customer is physically at a merchant location or a recent customer. Further, embodiments allow merchants to access, use and act on live and detailed data about their customers to improve customer service, increase interaction and optimize their marketing channels. For example, merchants may interact with embodiments of the present invention to integrate data collected during customer interactions on-location with existing marketing tools, such as email service providers, web analytics, customer relationship management (CRM) tools, reward programs, point-of-sale systems, other customer feedback types or the like. The merchant, corporation or consultant may also receive notifications through a mobile device or other computing device that consumer feedback has been made through the system and is above or below certain thresholds. The result is a system that provides improved customer interaction, enhanced customer experiences, and detailed and actionable data for merchants/corporations to leverage in marketing and advertising plans as well as track customer intelligence insights over time. To support the data collected, business users may associate free-form notes for their customers so that they can note specific preferences or customer engagements in greater detail and combine with other customer intelligence forms of feedback to receive a better insights of their consumers at a location, group, global, demographic level, etc.

Prior to a discussion of components of a system of the present invention, a brief illustrative example will be provided. In the illustrative example, a merchant (a Thai food restaurant with several locations in Southern California, including a San Diego location and a Los Angeles location) wishes to connect and interact with new and existing customers. The Thai food restaurant establishes an account with an operator of the present invention by signing up for an account (e.g., at www.chatterplug.com, invoiced internally or through reseller/referral partner), and providing detailed information about their business (including information specifying the physical restaurant locations, contact information, description, and other relevant information) as well as information about all of its current or outstanding promotions, rewards, discounts, deals or loyalty incentives it wishes to offer or display to its customers (as well as the terms of those promotions).

For example, the Thai restaurant may specify that frequent customers will be rewarded with a discount off a meal. Customers who frequently provide feedback (and/or customers who frequently comment on feedback while at the Thai restaurant) are to receive an even larger discount off a meal. In this manner, the Thai restaurant encourages participation by its customers (to provide feedback and frequent the restaurant) and rewards loyal and repeat customers who provide feedback. The Thai restaurant will be able to set the one or more specific levels of loyalty, and allocate a specific reward for each level if desired by each individual location or across an entire enterprise chain or group of locations owned by one individual, group or company. This allows the Thai restaurant to eliminate the need for customers to carry loyalty cards or punch cards, as they can reward them wirelessly. In some embodiments, The Thai restaurant could also aggregate all of its current or outstanding discounts, deals, rewards or promotions that the Thai restaurant making available to its customers either only on said application or on other deal or marketing services as well, so all of the Thai restaurant's deals and different marketing promotions are displayed in one place by the application and redeemable by consumers; thereby allowing said users to provide feedback and rate the restaurant since they have been validated as a real customer either because they are on location or through the redemption of the deal or marketing offer. The Thai restaurant can set specific time increments that specials and deals are redeemable, also choosing to make them available to all of their customers or only isolated segments. Redemption of deals and specials are tracked and displayed in the Thai restaurant's analytics section.

Further, pursuant to some embodiments, the restaurant can define settings which allow the restaurant to ensure that consumers who provide reviews and feedback actually visited one or more of the restaurant locations. Applicants have discovered that by only allowing feedback or reviews from actual patrons, while they actually patronizing the restaurant, that the quality and relevance of the feedback is increased.

Customers (or potential customers) of the Thai restaurant who have mobile devices, download a client application onto their mobile device (e.g., from an entity operating the system of the invention, such as, for example, www.chatterplug.com, or from an application consolidator such as the Apple iTunes Store, or the like) or a branded Thai restaurant application wherein said technology is integrated and interact with the application. For example, a customer in the San Diego area may search for a restaurant using the application and locate the Thai restaurant location in San Diego. The customer may read about the restaurant and view feedback and comments from other customers. If the customer visits the Thai restaurant, a geolocation feature within the phone (or by manual input or scanning of code or bump technology) will identify the fact that the customer is on-premise and only then will the application allow the customer to submit feedback (which may count towards the customer's ability to earn loyalty rewards offered by the Thai restaurant).

In some embodiments, the customer could validate that he or she is a customer of the location through redemption of a coupon, discount or deal or any sort to identify that the user is a customer and able to rate, review or provide feedback of the merchant. In some embodiments, active participation (e.g., submission of feedback or comments) is required to earn loyalty rewards or attain status levels. Frequent visits and/or feedback may earn the customer rewards, increase rank, or entitle them to other benefits. When the customer is at the Thai restaurant, he or she is encouraged to provide live, on-premise feedback, reviews about the experience or answer merchant questions. This feedback can be immediately available to other customers or potential customers, providing relevant, recent and real-time information for other users to use in their application usage. In some embodiments, the customer may also post feedback or information about their visit to the Thai restaurant after they leave the restaurant, but the feedback must be made within a predetermined period of time after leaving the business to encourage relevance due to the timeframe in which the feedback is submitted. In some embodiments, the technology described herein is also able to be utilized on outside mobile applications, to provide a branded experience. For example, a large restaurant chain may integrate this technology in their native mobile application, allowing their brand name to be represented in the application, and the supporting technology to stay the same (for example, features of embodiments of the present invention may be integrated into a branded mobile application distributed by national retailers, such as Starbucks, Target, United Airlines, or the Dallas Cowboys, for the merchant/corporation to receive real-time customer feedback and ratings with all of the supporting features and access to the software backend capabilities and analytics described herein).

This illustrative example will be continued in the discussion below to illustrate features of some embodiments.

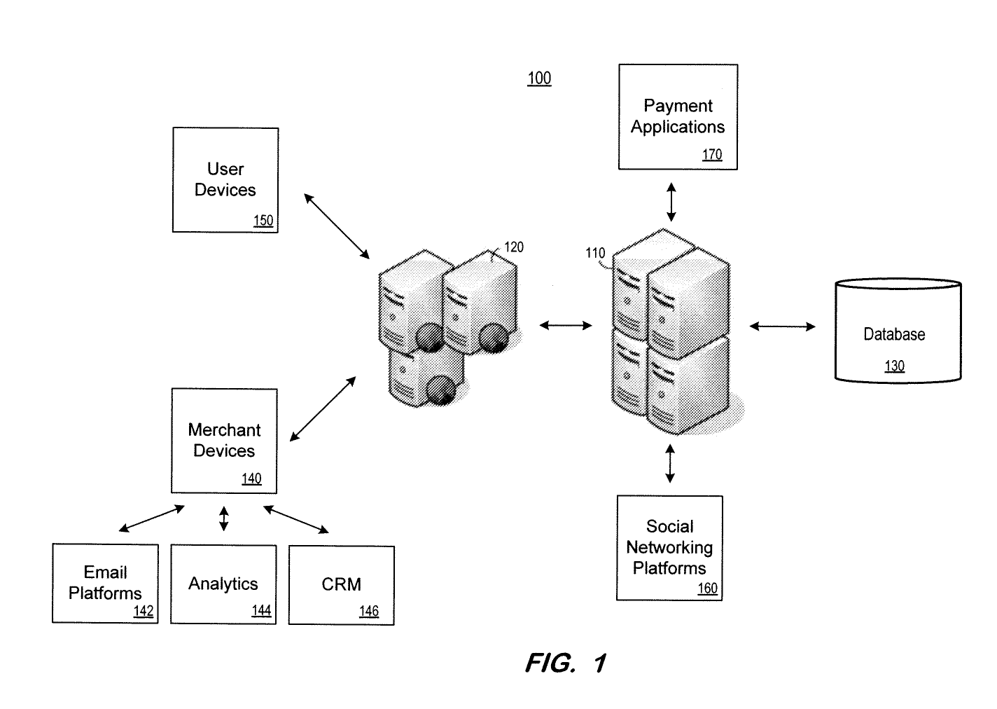

FIG. 1 is a block diagram of a system 100 according to some embodiments. System 100 includes a number of devices which, together, allow merchants to encourage customer interaction pursuant to the present invention. As shown, system 100 includes one or more application servers 110 in communication with one or more web servers 120. The application servers 110 are configured to operate application software to encourage customer interaction with a plurality of merchants. Each merchant may operate one or more merchant devices 140 to interact with application server 110 via the web servers 120 (and also with one or more customers). Each customer may operate one or more user devices 150 to interact with the application server 110 via the web servers 120 (and also with one or more merchants, including merchant locations). Application servers 110, web servers 120, merchant devices 140 and user devices 150 may each be implemented using any number of computing devices, each of which consists of any suitable combination of hardware and/or software. Although FIG. 1 depicts the flow of data directly between application servers 110, web servers 120 and other devices, such data may pass through any number of devices, networks, applications, etc. as it travels between the devices of the system. Embodiments are not limited to the architecture of system 100.

The system 100 supports a number of users operating user devices 150 and merchants operating merchant devices 140 to access the functionality described herein via a primary website (e.g., www.chatterplug.com or an internal database in which applicants technology is integrated through use of APIs). For example, a customer may be the customer of the example above, who is searching for or visiting the Thai food restaurant. The merchant may be, for example, the Thai food restaurant introduced above. Merchants of all sizes may benefit from use of features of the present invention, including small or medium sized merchants as well as larger chains, corporations or owners with a number of locations. In some embodiments, larger merchants may utilize the platform, allowing them to more closely manage location information, feedback, rewards, loyalty, deals, discounts or offers on one platform through a single interface and more closely integrate the data from the present invention with their existing reward programs, existing deal or discount programs, existing customer feedback mechanisms, analytics, CRM and marketing platforms, tools and vendors. In some embodiments, merchants may aggregate all of their outstanding marketing programs through other vendors onto said platform, so that all of their current deals, discounts, reward programs and the like can be viewed and redeemable from one location by its consumers.

The web servers 120 may be implemented as typical web servers to process requests based on web protocols. The application servers 110 execute the core backend application in response to requests received from the web servers 120. The core backend application may be embodied in program code (e.g., PHP5) executable by one or more processors of servers 110 to provide the functions described herein.

The backend application may be directly accessed (e.g., via one or more APIs) to provide or consume data from third party sources, including, for example, social networking platforms 160 (such as Facebook.com, twitter.com, or the like), point of sale systems and payment applications 170 (such as payment gateways, or the like). For example, in some embodiments, feedback or comments posted by customers and/or business updates and deals may be posted or transmitted to one or more social networks to increase distribution of the comments and information. As another example, in some embodiments, payment applications may be interfaced to allow customers to pay, or receive payment from, merchants (e.g., resulting from awards, or to pay an amount due) using the present invention. In this manner, embodiments allow close integration between reward and loyalty programs of merchants and payment applications. As another example, customer feedback could be integrated with existing point of sale or payment system data to combine profiles and allow better tracking of on-location customer feedback.

The application servers 110 may access, store and update data in a database 130 which may be, for example, a MySQL database or the like. The database 130 may store user data, feedback data, industry data, merchant data, offer data, CRM data, and other customer intelligence data to support the processes described herein. Although a single database 130 is shown, those skilled in the art will appreciate that a variety of separate or redundant databases may be provided.

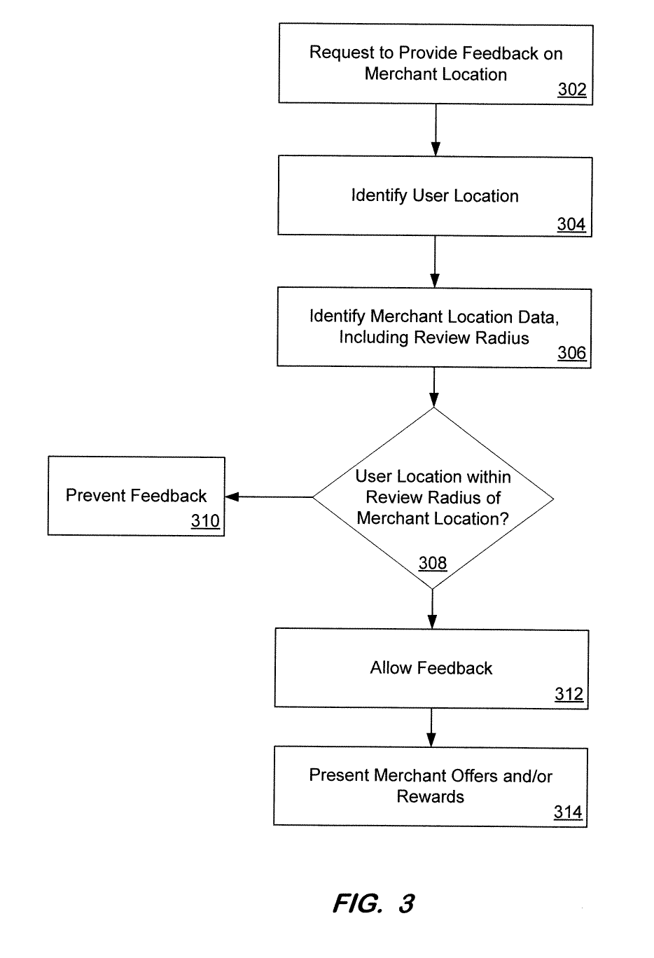

Pursuant to some embodiments, users, operating user devices 150 interact with the backend application (on application servers 110) via a wireless or wired network interface to connect with local businesses (such as merchants operating merchant devices 140) through live micro-blog feedback or dashboards. In some embodiments, user devices 150 may be or include desktop computers, laptop computers, personal digital assistants, tablet PCs, or mobile devices such as smart phones. In one currently preferred embodiment, users primarily interact with the backend application using mobile devices that are configured to interact with the web servers 120 over the internet, and to provide geolocation data associated with the location of the mobile device. Examples of user interfaces that may be presented on a user device 150 will be described further below in conjunction with FIGS. 3-12.

Pursuant to some embodiments, user devices 150 which are used to initiate reviews or feedback of merchant locations are typically mobile devices, such as mobile telephones, laptop computers, or tablet computers (such as the Apple® iPad or the like). Embodiments allow consumers operating such mobile user devices 150 to provide feedback or reviews associated with specific merchant locations participating in the system of the present invention. Pursuant to some embodiments the actual location of a mobile user device 150 is determined, and a review or feedback is allowed only if the mobile user device 150 is at (or within a reasonable range) of a merchant location.

By requiring that a user device 150 (and, presumably, the user operating the device) is actually at or in close proximity of a merchant location to be reviewed, embodiments ensure that reviews and feedback are accurate, relevant, and legitimate. Pursuant to some embodiments, the identification of the location of a user device 150 is performed using one or more geolocation techniques. For example, in some embodiments, identification of the location of a user device 150 is performed using either multilateration of radio signals between (several) radio towers of a cellular network and the user device 150, or simply via global positioning system (“GPS”) techniques. For example, in the situation where the user device 150 is a mobile telephone which is equipped with GPS functionality, the present location of the user device 150 may be determined through use of the device's GPS function. In some embodiments, user devices 150 may be configured with (or have downloaded and installed), a mobile application (such as an Android application or an iPhone application, or the like) which retrieves the mobile device's location from the operating system. As will be described further below, the use of this location information may include identifying a margin of error associated with the location information to determine whether the user device 150 is within a reasonable range of a specific merchant location.

In some embodiments, the location of a user device 150 in proximity to a merchant location may be determined based on whether the user device 150 is connected to a wireless network at the merchant location. For example, in some embodiments, a merchant may specify the identity of an open or closed WiFi network that is accessible to users at a merchant location. When a user device 150 is at, or within range of the WiFi network, the user is considered to be at the location, and features of embodiments of the present invention may be followed to allow the user to submit feedback or the like.

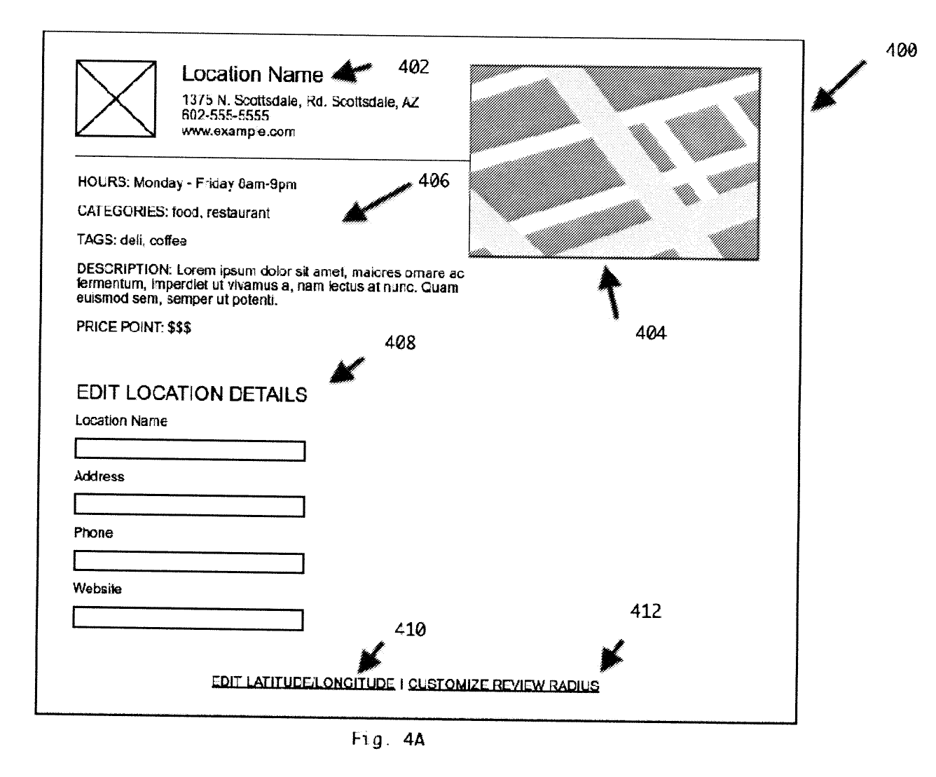

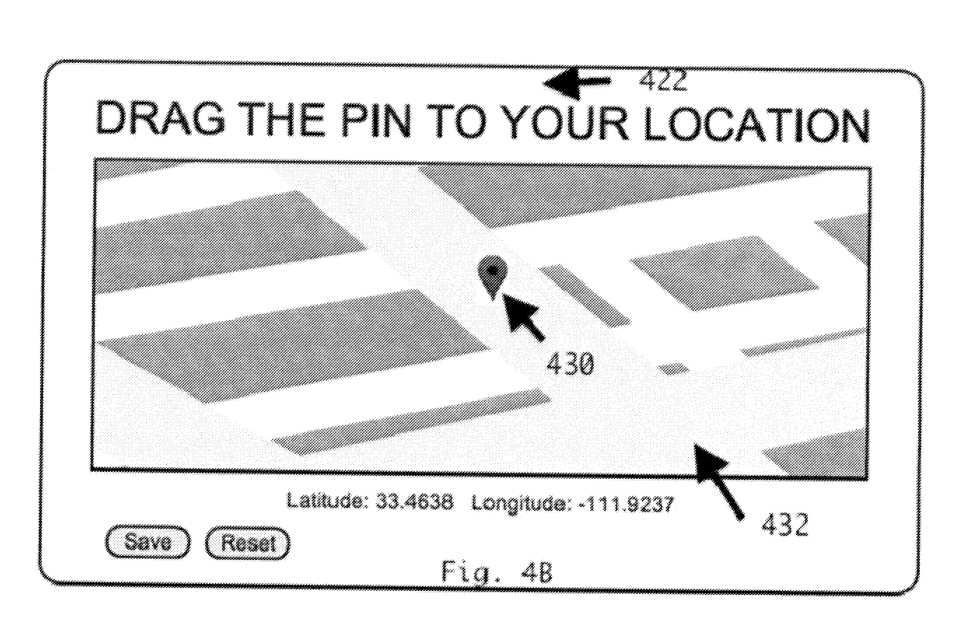

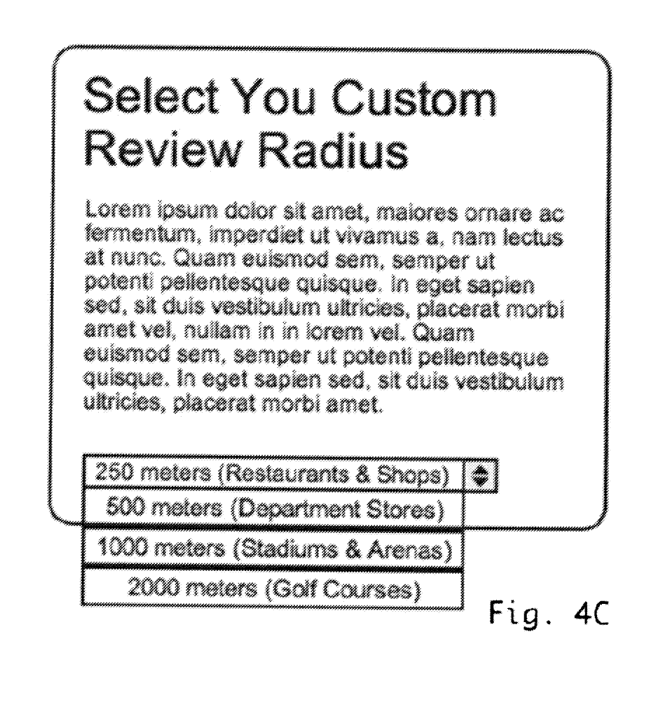

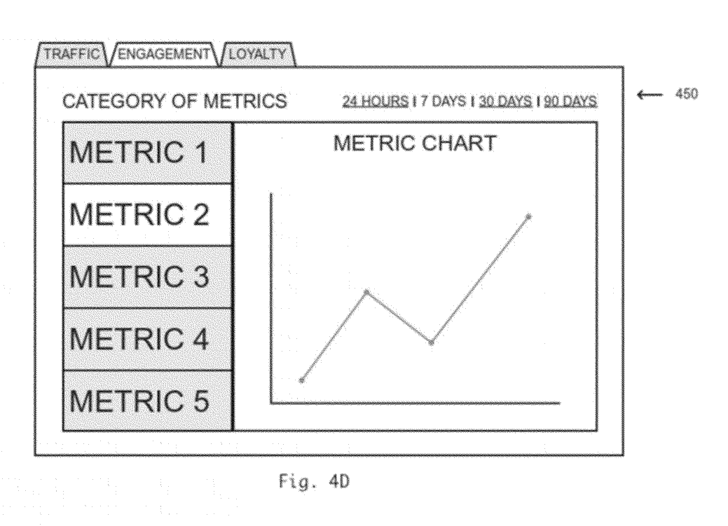

Pursuant to some embodiments, merchants, operating merchant devices 140, may interact with the backend application to create, manage and administer accounts that allow customers to locate, provide feedback, and interact with the merchant. Examples of user interfaces that may be presented to a merchant operating a merchant device 140 will be described further below in conjunction with FIG. 4. The merchant devices 140 may include interfaces or other integrations with tools or systems of the merchant. For example, in some embodiments, merchants may utilize data collected pursuant to the present invention to enhance their marketing efforts and interactions with consumers by providing the data to email platforms 142 (e.g., to enhance targeted mailing or follow up campaigns), analytics programs 144 (e.g., to optimize, measure and track offers and campaign performance), reward programs (e.g., to connect existing reward programs to on-premise users), other customer feedback channels (e.g. to give a broader view of the consumer feedback across the business/corporation by geographic area, demographics, consumer type or even down to the individual location level) and CRM systems 146 (e.g., to improve customer profiles and contact data connected to consumer needs, wants and recommendations). Some or all of these systems may be configured to receive data from application server 110 directly or through the merchant device 140. Continuing the illustrative example introduced above, the Thai restaurant may utilize data associated with actual customer purchasing and visit behavior to improve customer service, direct and indirect marketing campaigns and offers made to customers.

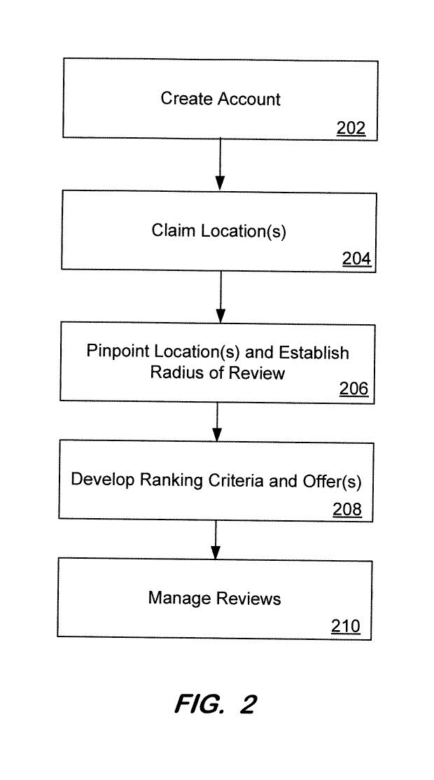

Reference is now made to FIG. 2 which illustrates a method that might be performed, for example, by a merchant device 140 interacting with other devices described in FIG. 1. The method of FIG. 2, in some embodiments, is performed under control of application software hosted on servers 120 and accessed via one or more merchant devices 140 in communication with the servers 120 via a network. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

Pursuant to some embodiments, merchants (including retailers, sports teams, affinity groups, or other entities wishing to solicit and reward feedback, reviews and comments from their customers) register to participate in the system of the present invention to allow customers to provide feedback and reviews. Each merchant wishing to participate follows a process such as the process 200 of FIG. 2. Processing begins at 202 where a merchant creates an account on the platform of the present invention. Creation of an account may include providing initial contact information as well as billing information. Once the account is set up, the merchant (or a designated administrator) interacts with the system of the present invention to claim one or more location(s) at 204. Processing at 204 may include logging into the new account (established at 202) and adding all of the locations owned or managed by the merchant. In some embodiments, adding locations is simplified by interacting with search features of the present invention where the merchant can search for and add locations using a search utility. For example, the Thai restaurant chain manager may search for “Thai restaurant, San Diego”, and select which location is theirs). Once the locations are identified, a simple check out feature may be performed to add the location(s) to the merchant's account. In some embodiments, merchants are billed for each location managed using features of the present invention.

In some embodiments, if any of a merchant's business locations are not listed in the search results, they can be added using a “Suggest a Venue” option. The correct business location and information is entered manually and saved. In some embodiments, once locations have been added, a merchant can interact with the venue information by verifying the address and contact information, placing the locations into appropriate groups based on location, store type or management assignments. A merchant can also assign access privileges so that the managers or stakeholders at these locations can begin leveraging features of the present invention to drive business.

For example, once a number of locations have been claimed, a merchant can add them to groups. Groups allow merchants to aggregate multiple locations and save time when reviewing analytics and setting rewards and specials for their multiple locations. Groups can be created based on location, store type, manager or any other criteria you like. Once a group is established, merchants will then be able to assign a group admin to access and administer each group and the locations that have been placed in that group. In some embodiments, group names can be changed and group admins can be deleted and changed with any potential new hires or lay-offs so the business owner is never as risk of losing information or access with turnover. In some embodiments, the primary business administrator will always be able to access every group and location—so she always has constant visibility to the experiences customers have at each location.

In some embodiments, for each location and group that a merchant has added, the merchant will be able to edit, manage and update all of the business location's consumer-facing details such as hours, description, street address, phone number and website address. An illustrative example of a user interface 400 that may be displayed to a merchant (or authorized merchant administrator) pursuant to some embodiments is shown in FIG. 4A. As depicted, embodiments allow information associated with a claimed location (402) to be edited via an “edit details” portion 408 of a user interface 400.

Pursuant to some embodiments, the merchant may also pinpoint location(s) and establish a radius of review (at step 206). For example, a merchant participating in the system of the present invention may log into an administrative interface and enter the precise latitude and longitude of each merchant location they manage. This latitude and longitude may be manually entered, or, in some embodiments, it may be entered using a graphical user interface which includes a satellite view or map of their address location. The merchant may further refine the center of their review radius by moving a pointer on the satellite view or map of their location. For example, if the San Diego location of the Thai restaurant is set off the street at 123 Main Street in San Diego by 100 meters, it may not be possible to accurately identify visitors if the street address is used as the center of the review radius (for example, a consumer who just purchased an order of take-out from the restaurant and who wants to type feedback, a review or comment as they walk to their car may leave the review radius quickly since the restaurant is 100 meters off the street). In some embodiments, the default setting, unless specifically overridden by a merchant or merchant administrator, is to use the merchant's street address to determine the latitude and longitude that serves as the center of the review radius.

Instead, the merchant (or an administrator responsible for configuring details of the merchant in the system of the present invention) may log into an administrative interface and use a pointer to pinpoint the center of their building. By establishing this pinpoint location, a precise center of the review radius may be set (with the center defined as a specific latitude and longitude). The Thai restaurant owner may also choose to widen the review radius from 100 meters to 250 meters to ensure that patrons may more conveniently enter feedback, reviews, redemptions, etc. As an example, referring again to FIG. 4A, a user interface 400 may be presented to a merchant (or authorized merchant administrator) allowing the merchant to not only specify the street address of a specific location, but to also enter a specific latitude/longitude 410 of the location. In some embodiments, this specific location information may be entered by presenting the user with a further window (illustrated as an example in FIG. 4B) which allows the user to drag a pointer 430 or click on a map 432 to set a center of a review radius for a specific merchant location. In some embodiments, a satellite view of the address may be displayed, allowing a merchant to drag the pointer 430 or click on the map 432 with a high degree of accuracy. For example, a merchant location with a street address that is substantially different than the center of the location may wish to drag the pointer 430 to a latitude/longitude that more accurately reflects the center of the location. As an illustrative embodiment, a football stadium may have a street address that is actually hundreds, if not thousands, of meters off of the center of the stadium. In such an example, the stadium owner (or authorized administrator), may wish to utilize features of the present invention to pick a center of the review radius which is closer to the center of the stadium, so that users of the mobile application of the present invention can more accurately be identified as “on location” when attempting to provide reviews or feedback.

Referring again to FIG. 4A, merchants are also provided with an ability to modify the “review radius”, for example, by interacting with item 412. Pursuant to some embodiments, recommended review radiuses may be provided to guide different types of merchants to select a radius that best fits their type of business. As shown in FIG. 4C, a restaurant or shop may have a smaller review radius, while a golf course may have a much larger review radius. In this manner, embodiments ensure that customers who are actually patrons of merchants are able to provide review and feedback if desired, while users who have not actually patronized a merchant location are prevented from doing so.

Pursuant to some embodiments, only consumers who have actually patronized the merchant location should be allowed to leave feedback or comments, and merchants are encouraged to set a review radius which accurately reflects their location and usage. Pursuant to some embodiments, the center of the review radius (defined by a latitude and longitude), the review radius, and the data from the mobile device, (including, in some embodiments, the device's ability to connect with a merchant's WiFi or other local network) are used to accurately specify the area or region in which a consumer is considered to be eligible to provide feedback or comments. In some embodiments, this determination is made on the mobile device (e.g., using the mobile application of the present invention). In other embodiments, the determination is made at the central server 120 or other remote system. The determination may be, for example, based on a comparison of the merchant location latitude and longitude (the center of the review radius) with the consumer's location latitude and longitude (as reported by the location based services of the mobile phone) adjusted for the margin of error reported by the location based services of the mobile phone in view of the established review radius. For example, if the merchant specifies a review radius of 250 meters, and the location based services of the mobile phone indicates a margin of error of 100 meters, and the consumer is 260 meters from the center of the review radius, then the mobile application will allow the consumer to leave a review. In some embodiments, the radius of review may be set on a group or location basis.

Processing continues at 208 where the merchant interacts with servers 120 to develop ranking criteria for consumers who submit reviews and feedback and to specify reward or offers to be provided. In some embodiments, a user interface is provided to direct a merchant how to develop the criteria and rewards. Pursuant to some currently preferred embodiments, the development of the criteria and reward levels is performed automatically by the system in response to the merchant providing answers to a series of questions (such as “What frequency do your BEST customers visit your location?”, etc.). In some embodiments, all of a merchant's marketing campaigns may be managed in a single location. For example, a daily deals tab or interface may allow the merchant to specify and edit daily or special offers.

Embodiments allow merchants to both provide incentives for relevant reviews and to consolidate general specials and deals. Merchants utilizing features of the present invention are able to provide their customers with certain ranks based on the quantity and quality of feedback or reviews they provide. Creating a rank rewards program is vital to driving repeat customers, as the use of rewards in exchange for quality content encourages users to provide merchants with more details about their personal experience. The information provided by customers allows merchants to improve their overall business and develop an individual relationship with customers by understanding their preferences and recognizing their needs. As this relationship develops, customers may increase the frequency with which they visit merchant locations. Merchants may also find that their efforts to provide individualized customer service can create advocacy and word-of-mouth recommendations for their business.

In some embodiments, to set up a rank rewards, a merchant may interact with application servers 110 via a browser pointed to a Rank Rewards tab on either a location, group or global basis. Editing a location will provide settings for only that location, while editing for a group will apply the settings to all locations within that group. The same goes for global, where a merchant can edit rank rewards settings for the merchant locations at one time through a single interface.

In the appropriate rank rewards tab a merchant can choose the default Bronze, Silver, Gold naming structure, or create a reward naming convention that is unique to the merchant's business and brand (e.g., Mickey, Minnie, Goofie; Clubhouse, Dugout, Bull Pen; Maguro, Yellowtail, Toro; etc.)

In some embodiments, for each reward level, a merchant may select the desired number of visits with a review and which type of deal or discount it will be: percentage off, dollars off, free item or other. Then enter the appropriate descriptor text. For example: To reward a user for 10 visits with a review with 10% off an entree, a merchant may select 10% off from a dropdown menu and enter “10% off any entree” in the descriptor field.

In some embodiments, to ensure that customers supply both a specific merchant location venue and other users with quality, informative, relevant, and actionable feedback, a “Like” button or similar functionality may be provided to allow merchants to reward users for writing feedback or reviews that are popular among other customers using the present invention. In general, if a certain review or feedback is widely regarded in the community, then it is likely useful to the merchant and should be encouraged and rewarded. In some embodiments, a merchant may specify how many “likes” a review must receive to equal a full visit with a review. In some embodiments, merchants may further reward customers with deals or rewards that are not directly tied to the number or quantity of reviews that a customer submits. In some embodiments, merchants may select to provide other deals or offers in a “specials” area.

Pursuant to some embodiments, a merchant may add a “special” offer by editing the current set of special offers on a location page (where the special is offered to customers at a single location), on a group page (where the special is offered at multiple locations in a group), and on a group rollup level (where the special is offered at all locations in a group).

Embodiments of the present invention allow a wide variety and type of offers, specials and rewards to be presented to their actual customers.

Processing may continue at 210 where a merchant interacts with the present invention to manage all feedback and interactions. Applicants have discovered that providing merchants with an ability to interact with live feedback from actual customers is an important component of improving customer interactions. However, just having the information and feedback is ineffective without an ability to handle and respond to the feedback. Embodiments provide merchants with real-time insight into feedback provided by their customers. Further, embodiments allow merchants to interact with customers based on the feedback to respond to negative feedback (e.g., to remedy a complaint or other issue). In some embodiments, merchant responses to customer feedback may be displayed to other customers, allowing remedial and proactive actions to be shown to a wide variety of customers.

Pursuant to some embodiments, a wide variety of reports and analytics may be provided to merchants to allow them to manage their customer interactions, and to gauge the success of reward programs or specials. An illustrative example of a report that may be displayed to a merchant pursuant to the present invention is shown in FIG. 4D. A merchant (or authorized administrator) may view the report 450 in a web browser, and may view at a glance how a rewards program is progressing, including the number of customers who have earned different statuses based on the amount and quality of feedback or reviews posted using the present invention. The merchant may also quickly view and monitor different offers and reward levels, and take appropriate action if an offer or reward needs to be updated or revised. A wide variety of other reports and analytics may also be provided, including reports relating to engagement and feedback. A live feed of all feedback and comments may be displayed to the merchant, allowing the merchant to quickly respond to any feedback (including positive, neutral or negative feedback).

The analytics may also be used to manage locations. For example, if a merchant has numerous locations or multiple work shifts during the day, embodiments of the present invention can be used to gauge how each location or shift is doing compared to others through analytics and the live feed from your customers. For example, if a merchant is constantly getting negative reviews between 8-10 am on Tuesday, the merchant may discover that an employee on that shift may need additional training or coaching.

Reference is now made to FIG. 3 which illustrates a method that might be performed, for example, by a user device 150 interacting with other devices described in FIG. 1. The method of FIG. 3, in some embodiments, is performed under control of application software downloaded on or otherwise operated by the user device 150. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

The method of FIG. 3 is a process 300 that may be initiated by a user operating user device 150 when the user wishes to submit feedback or make a review or other comment about their experience at a specific merchant location pursuant to the present invention. Continuing the illustrative example introduced above with the Thai restaurant, the process of FIG. 3 may be initiated by a person who is visiting the San Diego location of the Thai restaurant and who wants to submit feedback or make a review or other comment about the restaurant and their experience there. The process of FIG. 3 assumes that the user has a mobile device (such as a mobile phone) and that they have already downloaded and installed application software which allows them to submit feedback to the system of the present invention about participating merchant locations. Further, the user has already registered to participate in the review and feedback process of the present invention.

Process 300 begins at 302, where the user interacts with a mobile application (e.g., via a menu or other screen presented on a display of the mobile device) to request to provide feedback on the merchant location. For example, a customer eating at the San Diego location of the Thai restaurant chain may launch the application and provide some comments or feedback about their dining experience. Pursuant to some embodiments, the user's interaction with and submission of feedback is guided by a series of screens or user interfaces presented by the mobile application. Once the application has launched, it may remain operational until the user exits from the application. While operational, the mobile application repeatedly attempts to determine the present location 304 of the device 150. The location may be determined using a number of geolocation techniques. When a specific request from the user of the device 150 is received (e.g., to provide feedback about a current location), the mobile application attempts to identify the current location of the device at 304. In some embodiments, the current location of the device 150 is specified by information including a latitude, a longitude, and an estimated degree or margin of error of the location information.

Processing continues at 306 where the mobile application (in conjunction with the application servers 120) identifies merchant location data, including a review radius, associated with the merchant location to be reviewed. For example, this may include querying the application servers 120 to retrieve information associated with the merchant location, including the center of a review radius and a review radius previously specified by the merchant. Pursuant to some embodiments, systems of the present invention allow mobile devices 150 to use their location based technology to determine when a consumer is physically nearby or at a participating merchant location. However, existing mobile devices have a degree of error in their location, depending on the mobile device's distance from cell towers, etc. Because embodiments of the present invention require that consumers have actually visited a merchant location in order to provide feedback or reviews (and to earn rewards or participate in merchant surveys), it is important to ensure that a consumer actually visited or patronized a particular merchant location. Embodiments utilize data from merchants as well as mobile device location based services to provide a high degree of accuracy in location identification.

In some embodiments, the mobile application of the present invention receives location data from the mobile device, including a latitude, a longitude and a margin of error of the consumer's location. In other embodiments, the mobile application of the present invention receives location data from the mobile device by authentication of a specific location's wireless network. This data is compared to data provided by participating merchants regarding their exact location. In some embodiments, merchants are able to “pinpoint” or specify their location as well as a “review radius”. The merchant location data identified at 306 may include additional merchant location information such as the name of the merchant location, the physical address, hours of operation, and other information allowing reviews and comments about the merchant to be displayed on a mobile device operated by the consumer.

Processing at 308 includes determining whether the user's present location is within a review radius of the merchant location. In some embodiments, processing at 308 includes comparing the user's location (identified at 304) with the merchant location information (identified at 306) to determine if the user should be permitted to submit feedback or review associated with the merchant location (and/or to receive rewards or coupons associated with the merchant location). In some embodiments, the determination at 308 includes comparing merchant radius of review, the center of the radius of review, the user location, as well as a margin of error associated with the user location. If the determination at 308 is that the user is outside the review radius, processing continues at 310 where the user is prevented from providing feedback associated with the merchant location (and, in some embodiments, may also be prevented from receiving or viewing offers targeted at actual patrons of the merchant location).

If processing at 308 indicates that the user location is within the review radius, processing continues to 312 where the user is permitted to provide feedback or comments about the merchant location. That is, the user is considered to have actually patronized or visited the merchant location, and therefore his or her feedback should be considered relevant and permitted. The mobile application of the present invention may then permit the user to submit a review or other feedback. In some embodiments, users are encouraged to provide multiple items of feedback during their visit or patronage at the merchant location (e.g., a restaurant patron may submit an initial comment “The decor is great!”, as well as multiple comments during a meal such as “Service is kind of slow”, “The Phad Thai is amazing”, “Prices are great!”). In this way, embodiments allow customers to provide actual, real-time, and relevant feedback to merchants.

Processing may continue at 314 where the user may be presented with one or more rewards or offers from the merchant location. Some rewards may be based on the quantity and/or quality of feedback provided by the user, while others may be based on the fact that the user is visiting the location. Current outstanding rewards are visible on the rewards or specials tab, while in some embodiments, the rewards or offers may be presented earlier in a visit (e.g., when the user first arrives at the location), and in some embodiments, the rewards or offers may be presented after a visit, or before a visit to encourage the user to patronize a particular merchant location.

Pursuant to some embodiments, other types of feedback or interaction are possible between a merchant location and a user. For example, in some embodiments, merchants may conduct surveys of users. In some embodiments, such surveys may be displayed to users in the live feed of comments or information available to users at a merchant location. A user can respond to the survey publically or privately by providing answers to merchant survey questions (e.g., as responses to multiple choice questions, etc.). This allows the business to receive feedback around specific questions they have. Further, pursuant to some embodiments, by verifying that a user who provides such feedback is on location before answering or participating, the quality and relevance of the feedback is improved.

Referring briefly to FIGS. 4A-4D, a number of conceptual diagrams of a user interface are shown according to some embodiments. In particular, user interface represents a Web page that may be provided by application server 110 to a merchant operating a merchant device 140. As shown in the figures, a merchant who wishes to utilize features of the present invention may interact with a backend application (of application server 110) via an API feed, web interface and mobile application. In some embodiments, a merchant or corporation may locate information about their business and select to sign up and register to participate in the system of the present invention (e.g., by selecting “Sign Up Now” option, not shown). In other embodiments, a merchant or corporation may sign up and register through an invoicing process internally or have access through outside reseller or referral partners.

A merchant or corporation may then be presented with a registration page prompting for further information about the business. The merchant may be presented with additional registration pages allowing the merchant to specify rewards or loyalty programs or the like. Once registered, the detailed merchant information may be made available (with the reward or loyalty program details) to customers using a mobile application of the present invention or via the traditional web. The merchant may further be presented with location pages (such as that shown in FIGS. 4A and 4B) showing the location details, an analytics dashboard (such as shown in FIG. 4D for monitoring and analyzing data points surrounding customer interactions with the location), a feed of live or private customer comments and feedback, and the like. The merchant may further be able to edit the location details (which are presented to users), edit specials or notices, edit rewards, deals, discounts and loyalty program details or the like. Merchants may further be able to download or export data for import or use in other platforms (such as CRM platforms, additional customer feedback channels, email programs, reward programs or the like). Merchants can also manage logins for their various locations, granting permission to specific users that gives them access to data, location information, and feedback streams for that specific location. The result is a system that provides merchants with greater control and insight into interactions with their customers at retail locations and their customers that have redeemed deals or coupons at retail locations or online. A wide variety of other merchant screens and interfaces may be provided. Those shown in FIG. 4 are for illustrative purposes only.

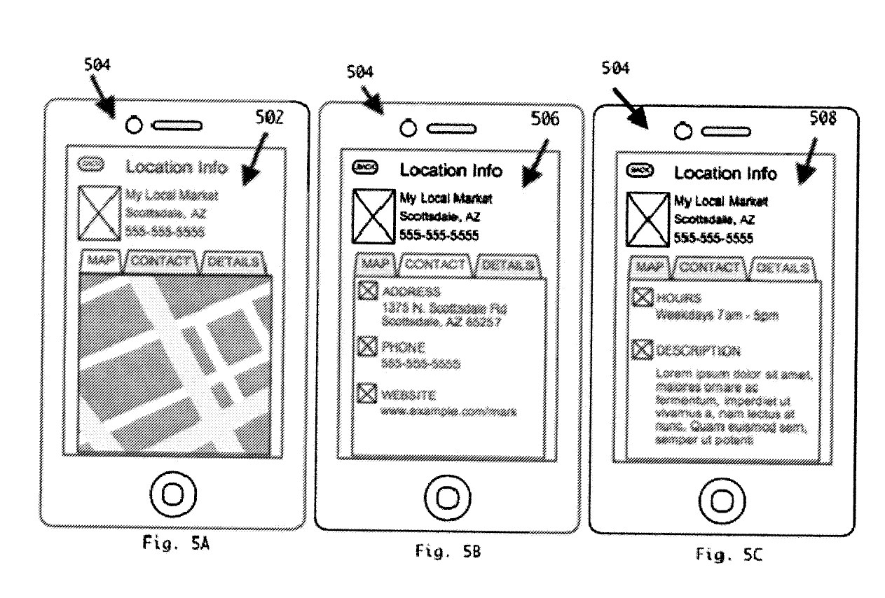

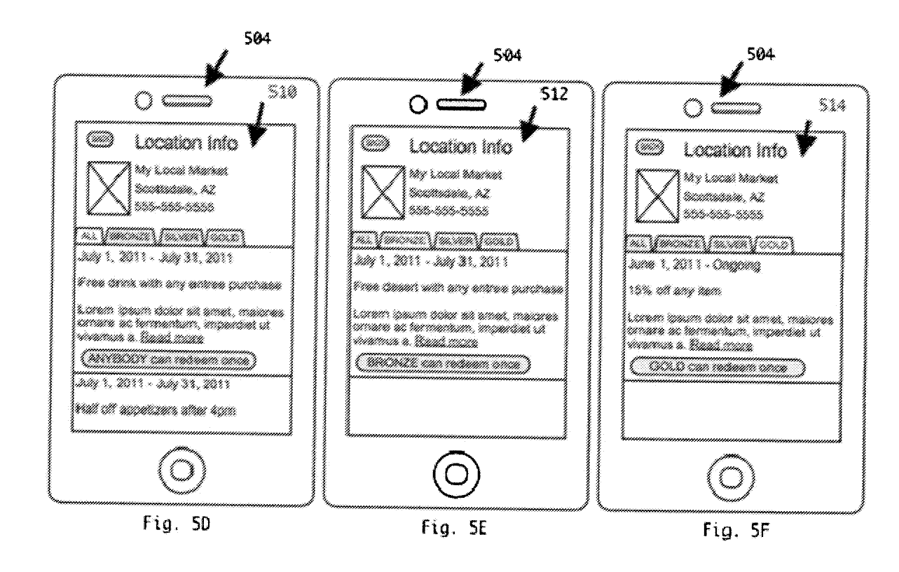

Customers may interact with the system of the present invention by accessing one or more Web pages or by downloading and using a mobile application of the present invention. Such customers may be presented with a wide variety of options and interfaces as well. FIGS. 5A through 5F will now be described to illustrate some possible interfaces as well as to describe features available to uses pursuant to some embodiments. When a user launches the mobile application of the present invention, a home or start page of an application may be displayed to a user operating a mobile device. The start page may include a number of options available to the user. For example, a user may be provided with options to research or locate a particular type of merchant (e.g., by viewing top “trending” locations, ranked by amount of feedback and comments from other users, by searching for “nearby” locations of different types, by checking their “favorites”, by searching for any location in their city or elsewhere, by search for “nearby” locations that have the best deals, discounts and marketing promotions listed, etc.). A user may also be presented with options to update their profile (e.g., to indicate desired preferences, locations, or the like) and to view their “rank” (e.g., the rank that they have achieved at various locations entitling them to specific rewards) and “notifications” (e.g., users are notified when another user or business comments, votes or replies to their feedback).

In some embodiments, the mobile application may detect or identify the location of the mobile device (e.g., using GPS or other location services). The location information may be used to present the user with a view of their current location, including information about the merchant associated with the location (if the user is at a merchant location which participates in the system of the present invention). An illustrative user interface 502 that may be displayed on a mobile device 504 in such a situation is shown in FIG. 5A. The user interface 502 provides the user with information about the specific merchant location, including a map view, contact information (e.g., as shown in the user interface 506 of FIG. 5B), and other details, including hours of operation and a description of the merchant location (e.g., as shown in the user interface 508 of FIG. 5C).

In some embodiments, users may interact with the mobile application of the present invention to research merchants that are nearby their current location or just see a particular merchants locations if present application is integrated into a specific merchant's branded application. For example, a user may be presented with a user interface which provides several categories of merchants (which may, for example, be specified as preferences by the user in their profile or different sorting options available to the user) along with current specials, deals, promotions, ratings and feedback about each establishment. For example, the user in the illustrative example may see that they are near a Thai restaurant that has some favorable deals and specials available, is highly rated, and has a large amount of feedback, using the content of the feedback in their decision-making process. The ratings and feedback are, in some embodiments, provided by other users of the system of the present invention who are determined by technology to have physically have been at that specific location.

In some embodiments, a user may also view “trending” locations near them. The “trending” locations are merchant locations for which a large amount of feedback or ratings have recently been provided by other users of the present invention. Such trending data may show a user where the most frequently reviewed and visited locations are in their local or city area on that day (e.g., where the “hot” locations are).

Pursuant to some embodiments, users may be provided with a number of ways to search or locate desired merchants, including a search by category or search by name, keyword or location. In other embodiments, users may be provided with other ways to search or locate desired merchants through a listing or ranking of the best deals, discounts or marketing promotions in their area.

A user who has selected a particular merchant to investigate or learn about may be presented with a user interface having details about the merchant as well as recent comments or feedback from other users. The user of the mobile device may interact with a user interface to navigate to the location as well as to provide feedback at the location once they arrive and the mobile device has confirmed that they are within range of the businesses' listed address or inputted coordinates (or the user has verified their location through the “bump” method, by manual input or scanning of a code to guarantee location, or by redemption of a deal, discount or other type of marketing offer obtained outside of the application). In some embodiments, if a user wishes to visit the merchant, he or she may make a reservation (if the merchant is a restaurant, for example) through the mobile device and the application. In some embodiments, a user may interact with the user interface to place an order or pay for an item provided by the merchant (e.g., to order take out from a restaurant, or to purchase an item from a retailer, etc.). While at a merchant location, interfaces such as those shown in FIG. 5D-F may be shown, allowing the user to view different reward levels provided by the merchant to users providing certain levels of feedback or interaction with the merchant location. For example, as shown in FIG. 5D, a user interface 510 may be displayed showing “all” of the rewards or benefits available to users at the merchant location. As shown in FIG. 5E, a user interface 512 may be displayed showing rewards earned by users achieving a “bronze” level of status, while FIG. 5F shows a user interface 514 that may be displayed showing rewards earned by users achieving a “gold” level of status. Each of the rewards, and reward levels, may be specified by a merchant (or authorized administrator) as described further above. Further, the qualification requirements for some or all of the reward levels may be specified as requiring that a user actually visit and patronize the merchant location to earn a reward. In this manner, merchants are able to encourage visitation and patronage, and users who submit feedback or comments about a merchant location are required to have actually been a customer by visiting the merchant location or redemption of product or services.

Further, users may “like” or comment on the comments or feedback provided by other users. Such a user interface allows users to see what is going on live at the location as well as to encourage constructive feedback by others. In some embodiments, when a user's feedback is “liked” by others, it helps to increase their status at the specific location being reviewed. Further, in some embodiments, users who do not visit merchants, generate feedback, or provide content will not be able to accrue “rank” or, in some embodiments, earn deals, discounts or loyalty or reward points (however, they are still able to monitor activity and browse feedback of others). The result is a system that encourages and rewards active participation by users to generate useful and accurate information. Such a merchant-moderated feedback environment may be used to reward all writers of feedback with tangible rewards.

Further user interfaces may be provided on a mobile device operating a mobile application of the present invention which prompt a user to provide “on the spot” feedback, rating or review of a location he or she is currently at (or within a predetermined period of time after departing a location or has recently redeemed a deal, coupon or other marketing offer at that particular location). In some embodiments, a user may further be prompted to take a picture or create a video in conjunction with their feedback. In some embodiments, feedback may be asked from a consumer through specific questions, ratings or in a survey-like manner by the merchant or corporation at the location, group or global level. This feedback may be viewed publically or privately depending on options and features. In some embodiments feedback to these specific questions, ratings or survey-like questions may count towards a users loyalty ranking achievement or towards achievement of a special. In some embodiments, users may link their feedback to outside social sharing platforms such as Facebook, Twitter, and LinkedIn among others.

The mobile application may also display or provide a number of user—specific screens. For example, a user may update or modify a user profile to further enhance their feedback and update personal information, as well as to ensure that merchants are able to provide deals, discounts, rewards and loyalty incentives to the user. The user profile may include information about user preferences (such as food types, nutrition, retail interests, travel habits, or the like).

Further, a user may be able to store, view and update favorite merchant locations (in different geographical areas). A user may also select to view their past feedback history as well as the past feedback of others. In some embodiments, a user may choose to “follow” the feedback, recommendations and interaction of other users (e.g., where a user finds that another user's reviews or comments are particularly helpful or has similar taste, may choose to follow that other user's activity to find locations or information that may be helpful). In some embodiments, a user may further be able to “import” contact lists or friends from other social networks or contact systems. For example, a user may be able to import information about friends or contacts from services or systems such as Facebook.com, Gmail, Twitter.com, or the like to follow on the present invention. Application users will see a “live feed” that displays all of the feedback that users they follow generate, as well as broadcasts by the merchants or corporations that they have selected as a “favorite”.

Users who actively participate and visit participating merchant or corporation locations may be rewarded with rank levels that may be associated with merchant rewards, deals or bonuses. For example, a user may attain different status levels at different merchant locations. Each merchant, in some embodiments, may specify different criteria for attaining each rank level. Further, each merchant may specify different reward, deal or discount payments or bonuses based on attainment of those levels and in some embodiments may integrate those in with their existing reward programs or point of sale systems to ensure continuity throughout their organization. For example, the Thai restaurant may specify that users who reach “gold” rank are entitled to a certain dollar reduction in their bill on their next visit. In some embodiments, users may redeem this rank by presenting their mobile device to a clerk at the merchant location (who may then scan or update a merchant terminal, merchant portal or the user's mobile device of the present invention to indicate that the reward was redeemed). This will allow merchants to track redemption rates of deals, discount and marketing offers of all types, and derive individual user redemption and preferences as well a validate that the user is an actual customer of said merchant. In some embodiments, a business will integrate and host their existing loyalty program on the platform. For example, an airline may award 5,000 bonus miles for providing feedback at a specific airport or multiple airports through a mobile device operating a mobile application of the present invention or the airline's own branded mobile application.

Pursuant to some embodiments, merchants may utilize the system of the present invention to promote interaction with customers in a variety of ways, including by awarding different rebates or rewards to users who achieve certain “rank” levels of interaction. Further, merchants may issue or distribute deals or advertisements to users of the present invention or new a audience to gain new customers, which requires a “tipping point’ or certain number of users to participate. As a specific illustrative example, the Thai restaurant may advertise a promotion in which it will offer a rebate, discount or other incentive to users if a certain number of users visit or buy a deal or marketing offer at the Thai restaurant. For example, if 20 people visit or buy a specific deal or marketing offer for the Thai restaurant on Friday, December 10, everyone will receive a free meal that day or the next time they visit the Thai restaurant and will be prompted to rate or provide feedback for their experience. Those skilled in the art will appreciate that other promotional techniques may also be used with beneficial results using the present invention. For example, in some embodiments, merchants may provide gift cards or club cards which are integrated with the system of the present invention. In some embodiments, such gift cards or club cards may be “virtual” or issued and redeemed electronically through a user's mobile device. In some embodiments, rewards or benefits earned by a user through interaction with the present invention may be delivered to the recipient using the mobile device and the present invention.

Those skilled in the art will appreciate that a wide variety of other or additional interfaces may be provided to allow users and merchants to interact with embodiments of the present invention. Further, users (registered and not registered) may interact with and view comments and venue information from other devices including desktop or other computing devices connected to the Internet. Further, pursuant to some embodiments, certain features of the application described herein may be integrated into an existing application. For example, a merchant such as Subway® can gather guaranteed on-location feedback and view data through a web-hosted business back-end. Other features such as favoriting, rank rewards and specials can also be run through integration. This allows a merchant to promote their own application, while enjoying the benefits of systems of the present invention.

The several embodiments described herein are solely for the purpose of illustration. Therefore, persons in the art will recognize from this description that other embodiments may be practiced with various modifications and alterations.

What is claimed is:

1. A method for operating a mobile device, comprising:
generating, from the mobile device, a request by a user to provide feedback associated with an experience at a merchant;
identifying device location data associated with a current location of the mobile device;
identifying merchant location data associated with a location of said merchant, said merchant location data including information identifying a permitted review radius;
determining whether said current location of said mobile device is within said permitted review radius; and
permitting said user to provide said feedback if said mobile device is within said permitted review radius.

2. The method of claim 1, wherein said determining whether said current location of said mobile device is within said permitted review radius indicates that said mobile device is not within said permitted review radius, the method further comprising:
preventing said user from providing said feedback.

3. The method of claim 1, wherein said device location data comprises:
a latitude and a longitude of said mobile device; and
a margin of error of said device location data.

4. The method of claim 3, wherein said determining whether current location of said mobile device is within said permitted review radius includes comparing said latitude and longitude of said mobile device with said margin of error to said permitted review radius.

5. The method of claim 1, further comprising:
communicating at least a first merchant offer to said mobile device based on said current location of said mobile device.

6. The method of claim 5, further comprising:
selecting said at least first merchant offer based on a status of said user operating said mobile device.

7. The method of claim 6, wherein said status of said user is determined based at least in part on: (i) a quantity of feedback provided by said user, and (ii) a quality of feedback provided by said user.

8. The method of claim 1, wherein said merchant location data is specified by said merchant.

9. The method of claim 1, wherein said merchant location data is identified based on an address of said merchant.

10. A method, comprising:
generating, from a mobile device, a request by a user to provide feedback associated with an experience at a merchant location;
verifying that said mobile device is actually present at said merchant location; and
permitting said user to provide said feedback using said mobile device if said mobile device is at said merchant location.

11. The method of claim 10, wherein said verifying comprises:
identifying device location data associated with a current location of said mobile device;
identifying merchant location data associated with a location of said merchant, said merchant location data including information identifying a permitted review radius; and
determining whether said current location of said mobile device is within said permitted review radius.

12. The method of claim 10, wherein said verifying comprises at least one of: (i) verifying that a location of said mobile device matches a known location of said merchant location; (ii) verifying an action associated with said mobile device involving said merchant location.

13. The method of claim 12, wherein said verifying that a location of said mobile device matches a known location of said merchant further comprises at least one of: (i) detecting that said mobile device is connected with a known wireless network at said merchant location, (ii) detecting location information associated with said mobile device, (iii) detecting a transaction involving said mobile device and said merchant location, (iv) detecting a code scan by said mobile device from said merchant location, and (v) detecting a checkin of said mobile device at said merchant location.
